(19) United States
(12) Patent Application Publication
(10) Pub. No.: US 2024/0041131 A1
(43) Pub. Date: Feb. 8, 2024

(54) AEROSOL-GENERATING DEVICE AND SYSTEM COMPRISING AN INDUCTIVE HEATING DEVICE AND METHOD OF OPERATING THE SAME

(71) Applicant: Philip Morris Products S.A., Neuchatel (CH)

(72) Inventors: Yannick BUTIN, Marin-Epagnier (CH); Lucas GATTONI, Morges (CH); Farhang MOHSENI, Neuchatel (CH); Milica NESOVIC, Neuchatel (CH); Enrico STURA, Palezieux-Village (CH)

(73) Assignee: Philip Morris Products S.A., Neuchatel (CH)

(21) Appl. No.: 18/258,718

(22) PCT Filed: Dec. 23, 2021
(86) PCT No.: PCT/EP2021/087543

§ 371 Date: Jun. 21, 2023

(30) Foreign Application Priority Data
Dec. 23, 2020 (EP) 20217031.2

(51) Int. Cl. A24F 40/57; H05B 6/06; A24F 40/20; A24F 40/465; A24F 40/53

(52) U.S. Cl. CPC A24F 40/57; H05B 6/06; A24F 40/20; A24F 40/465; A24F 40/53; H05B 2206/023

(57) ABSTRACT

A method for controlling aerosol production in an aerosol-generating device is provided, the aerosol-generating device including an inductive heating arrangement and a power source configured to provide power to the inductive heating arrangement, and the method including: performing, during a first heating phase during user operation of the aerosol-generating device for producing an aerosol, a calibration process including measuring one or more calibration values associated with a susceptor inductively coupled to the inductive heating arrangement, the susceptor being configured to heat an aerosol-forming substrate; and during a second heating phase during the user operation of the aerosol-generating device for producing the aerosol, controlling power provided to the inductive heating arrangement such that a temperature of the susceptor is adjusted based on the one or more calibration values. An aerosol-generating system is also provided, including the aerosol-generating device, and an aerosol-generating article including the aerosol-forming substrate and the susceptor.

The present disclosure relates to an inductive heating device for heating an aerosol-forming substrate. The present invention further relates to an aerosol-generating device comprising such an inductive heating device and a method for controlling aerosol production in the aerosol-generating device.

Aerosol-generating devices may comprise an electrically operated heat source that is configured to heat an aerosol-forming substrate to produce an aerosol. The electrically operated heat source may be an inductive heating device. Inductive heating devices typically comprise an inductor that inductively couples to a susceptor. The inductor generates an alternating magnetic field that causes heating in the susceptor. Typically, the susceptor is in direct contact with the aerosol-forming substrate and heat is transferred from the susceptor to the aerosol-forming substrate primarily by conduction. The temperature of the aerosol-forming substrate may be controlled by controlling the temperature of the susceptor. Therefore, it is important for such aerosol-generating devices to accurately monitor and control the temperature of the susceptor to ensure optimum generation and delivery of an aerosol to a user.

It would be desirable to provide temperature monitoring and control of an inductive heating device that is accurate, reliable and inexpensive.

According to an embodiment of the present invention, there is provided a method for controlling aerosol production in an aerosol-generating device. The device comprises an inductive heating arrangement and a power source for providing power to the inductive heating arrangement. The method may comprise: performing, during a first heating phase during user operation of the aerosol-generating device for producing an aerosol, a calibration process for measuring one or more calibration values associated with a susceptor inductively coupled to the inductive heating arrangement, wherein the susceptor is configured to heat an aerosol-forming substrate; and during a second heating phase during user operating of the aerosol-generating device for producing an aerosol, controlling power provided to the inductive heating arrangement such that the temperature of the susceptor is adjusted based on the one or more calibration values.

Performing calibration during user operation of the aerosol-generating device means that the calibration values used to control the heating process are more accurate and reliable than if the calibration process were performed at manufacturing. This also improves flexibility and cost-effectiveness in that the aerosol-generating device may be calibrated for more than one type of susceptor. This is especially important if the susceptor forms part of a separate aerosol-generating article that does not form part of the aerosol-generating device. In such circumstances, calibration at manufacturing is not possible.

The inductive heating arrangement may comprise a DC/AC converter and an inductor connected to the DC/AC converter, wherein the susceptor may be arranged to inductively couple to the inductor. Power from the power source may be supplied continually to the inductor, via the DC/AC converter. Power may be supplied from the power source is supplied to the inductor, via the DC/AC converter, as a plurality of pulses, each pulse separated by a time interval. Adjusting the temperature of the susceptor may comprise controlling the time interval between each of the plurality of pulses. Adjusting the temperature of the susceptor may comprise controlling a length of each pulse of the plurality of pulses.

Controlling the power provided to the inductive heating arrangement may comprise adjusting one of a current value, a conductance value and a resistance value associated with the susceptor.

Performing the calibration process may comprise the steps of: (i) controlling the power provided to the inductive heating arrangement to cause an increase of the temperature of the susceptor; (ii) monitoring a current value associated with the susceptor; (iii) interrupting provision of power to the inductive heating arrangement when the current value reaches a maximum, wherein the current value at the maximum corresponds to a second calibration temperature of the susceptor; and (iv) monitoring the current value associated with the susceptor until the current value reaches a minimum, wherein the current value at the minimum corresponds to a first calibration temperature of the susceptor.

Performing the calibration process may further comprise repeating steps i) to iv) when the current value associated with the susceptor reaches the minimum. Performing the calibration process may further comprise, during repetition of steps i) to iv), storing the current value at the maximum as a calibration value of the one or more calibration values and storing the current value at the minimum as a calibration value of the one or more calibration values.

Controlling the power provided to the inductive heating arrangement may comprise maintaining a current value associated with the susceptor between a first current value corresponding to the first calibration temperature and a second current value corresponding to the second calibration temperature.

Performing the calibration process may comprise the steps of: i) controlling the power provided to the inductive heating arrangement to cause an increase of the temperature of the susceptor; ii) monitoring a conductance value associated with the susceptor; iii) interrupting provision of power to the inductive heating arrangement when the conductance value reaches a maximum, wherein the conductance value at the maximum corresponds to a second calibration temperature of the susceptor; and iv) monitoring the conductance value associated with the susceptor until the conductance value reaches a minimum, wherein the conductance value at the minimum corresponds to a first calibration temperature of the susceptor.

Performing the calibration process may further comprise repeating steps i) to iv) when the conductance value associated with the susceptor reaches the minimum. Performing the calibration process may further comprise, during repetition of steps i) to iv), storing the conductance value at the maximum as a calibration value of the one or more calibration values and storing the conductance value at the minimum as a calibration value of the one or more calibration values.

Controlling the power provided to the inductive heating arrangement may comprise maintaining a conductance value associated with the susceptor between a first conductance value corresponding to the first calibration temperature and a second conductance value corresponding to the second calibration temperature.

Performing the calibration process may comprise the steps of: i) controlling the power provided to the inductive heating arrangement to cause an increase of the temperature of the susceptor; ii) monitoring a resistance value associated with the susceptor; iii) interrupting provision of power to the inductive heating arrangement when the resistance value reaches a minimum, wherein the resistance value at the minimum corresponds to a second calibration temperature of the susceptor; and iv) monitoring the resistance value associated with the susceptor until the resistance value reaches a maximum, wherein the resistance value at the maximum corresponds to a first calibration temperature of the susceptor.

Performing the calibration process may further comprise repeating steps i) to iv) when the resistance value associated with the susceptor reaches the maximum. Performing the calibration process may further comprise, during repetition of steps i) to iv), storing the resistance value at the minimum as a calibration value of the one or more calibration values and storing the resistance value at the maximum as a calibration value of the one or more calibration values.

Controlling the power provided to the inductive heating arrangement may comprise maintaining a resistance value associated with the susceptor between a first resistance value corresponding to the first calibration temperature and a second resistance value corresponding to the second calibration temperature.

The second calibration temperature of the susceptor may correspond to a Curie temperature of a material of the susceptor. The first calibration temperature of the susceptor may correspond to a temperature at maximum permeability of the material of the susceptor.

The susceptor may comprise a first susceptor material having a first Curie temperature and a second susceptor material having a second Curie temperature, wherein the second Curie temperature is lower than the first Curie temperature. The second calibration temperature may correspond to the second Curie temperature of the second susceptor material. The first and the second susceptor materials are preferably two separate susceptor materials that are joined together and therefore are in intimate physical contact with each other, whereby it is ensured that both susceptor materials have the same temperature due to thermal conduction. The two susceptor materials are preferably two layers or strips that are joined along one of their major surfaces. The susceptor may further comprise yet an additional third layer of susceptor material. The third layer of susceptor material may be made of the first susceptor material. A thickness of the third layer of susceptor material may be less than a thickness of the second layer of the second susceptor material.

The first calibration temperature may be between 150 degrees Celsius and 350 degrees Celsius. The second calibration temperature may be between 200 degrees Celsius and 400 degrees Celsius. A temperature difference between the first calibration temperature and the second calibration temperature may be at least 50 degrees Celsius.

Performing the calibration process may further comprise repeating steps (i) to (iv) when the conductance value associated with the susceptor reaches the minimum.

Performing the calibration process may further comprise, during repetition of steps (i) to (iv), storing the conductance value at the maximum as a calibration value of the one or more calibration values and storing the conductance value at the minimum as a calibration value of the one or more calibration values.

The calibration process is both quick and reliable without delaying aerosol-production. Furthermore, repeating the steps of the calibration process significantly improves subsequent temperature regulation because heat has had more time to distribute within the substrate. Performing the calibration process based on at least a measured current value assumes that the voltage of the power source remains constant. Thus, monitoring a conductance value or a resistance value (and therefore using both measured values of current and voltage) during the calibration process further improves the reliability of the calibration in case the voltage of the power source changes over a long period of time (for example, after being recharged many times).

The method may further comprise, during the second heating phase, performing the calibration process for measuring one or more calibration values associated with the susceptor in response to detecting one or more of: a predetermined duration of time, a predetermined number of user puffs, and a predetermined voltage value of the power source.

Conditions may change during user operation of the aerosol-generating device. For example, the susceptor may move relative to the inductive heating arrangement, the power source (for example, a battery) may lose some efficiency over time and so on. Accordingly, performing the calibration process in response to detecting one or more of a predetermined duration of time, a predetermined number of user puffs, and a predetermined voltage value of the power source ensures the reliability of the calibration values, thereby ensuring that optimal temperature regulation is maintained throughout use of the aerosol-generating device.

The method may further comprise, during the first heating phase, performing a pre-heating process. The pre-heating process may be performed before the calibration process. The pre-heating process may have a predetermined duration. The pre-determined duration of the pre-heating process may be between 10 seconds and 15 seconds.

The pre-heating process may comprise the steps of: i) controlling the power provided to the inductive heating arrangement to cause an increase of the temperature of the susceptor; ii) monitoring at least a current value associated with the susceptor; and iii) interrupting provision of power to the inductive heating arrangement when the current value reaches a minimum.

If the current value reaches a minimum before the end of the predetermined duration of the pre-heating process, steps i) to iii) of the pre-heating process may be repeated until the end of the pre-determined duration of the pre-heating process.

If the current value associated with the susceptor does not reach a minimum during the predetermined duration of pre-heating process, operation of the aerosol-generating device may be ceased.

The pre-heating process may comprise the steps of: (i) controlling the power provided to the inductive heating arrangement to cause an increase of the temperature of the susceptor; (ii) monitoring a conductance value associated with the susceptor; and (iii) interrupting provision of power to the inductive heating arrangement when the conductance value reaches a minimum.

The method may further comprise, if the conductance value reaches a minimum before the end of the predetermined duration of the pre-heating process, repeating steps (i) to (iii) of the pre-heating process until the end of the pre-determined duration of the pre-heating process.

The pre-determined duration enables heat to spread within the substrate in time to reach the minimum conductance value measured during the calibration process no matter what the physical condition of the substrate (for example, if the substrate is dry or humid). This ensures reliability of the calibration process.

The method may further comprise, if the conductance value associated with the susceptor does not reach a minimum during the predetermined duration of pre-heating process, ceasing operation of the aerosol-generating device.

The pre-heating process may comprise the steps of: i) controlling the power provided to the inductive heating arrangement to cause an increase of the temperature of the susceptor; ii) monitoring a resistance value associated with the susceptor; and iii) interrupting provision of power to the inductive heating arrangement when the resistance value reaches a maximum.

If the resistance value reaches a maximum before the end of the predetermined duration of the pre-heating process, steps i) to iii) of the pre-heating process may be repeated until the end of the pre-determined duration of the pre-heating process.

If the resistance value associated with the susceptor does not reach a maximum during the predetermined duration of pre-heating process, the method may further comprise ceasing operation of the aerosol-generating device.

The pre-heating process allows for heat to spread within the substrate before launching the calibration process, thereby further improving the reliability of the calibration values.

The susceptor is preferably part of an aerosol-generating article that is configured to be inserted into the aerosol-generating device. Aerosol-generating articles that are not configured to be used with the aerosol-generating device will not exhibit the same behavior as authorized aerosol-generating articles. Specifically, the conductance associated with the susceptor will not reach a minimum during the pre-determined duration of the pre-heating process. Accordingly, this prevents the use of non-authorized aerosol-generating articles.

During the pre-heating process, power from the power source may be supplied continuously to the inductor, via the DC/AC converter.

The calibration process may be performed in response to detecting the end of the predetermined duration of the pre-heating process.

The pre-heating process may be performed in response to detecting a user input. The user input may correspond to a user activation of the aerosol-generating device.

The susceptor and the aerosol-forming substrate may form part of an aerosol-generating article. The aerosol-generating device may be configured to removably receive the aerosol-generating article. The pre-heating process may be performed in response to detecting a presence of an aerosol-generating article.

Controlling the power provided to the inductive heating arrangement during the second heating phase may comprise controlling the power to the inductive heating arrangement to cause a step-wise increase of a temperature of the susceptor from a first operating temperature to a second operating temperature.

The first operating temperature may be sufficient for the aerosol-forming substrate to form an aerosol. The step-wise increase of the temperature of the susceptor may comprise at least three consecutive temperature steps. Each temperature step may have a duration. For the duration of each temperature step, the temperature of the susceptor may be maintained at a predetermined temperature.

Controlling the power provided to the inductive heating arrangement to cause the step-wise increase of a temperature of the susceptor enables generation of an aerosol over a sustained period encompassing the full user experience of a number of puffs, for example 14 puffs, or a predetermined time interval, such as 6 minutes, where the deliveries (nicotine, flavors, aerosol volume and so on) are substantially constant for each puff throughout the user experience.

Specifically, the stepwise increase if the temperature of the susceptor prevents the reduction of aerosol delivery due to substrate depletion and reduced thermodiffusion over time. Furthermore, the step-wise increase in temperature allows for the heat to spread within the substrate at each step.

Maintaining the temperature of the susceptor at the predetermined temperature may comprise interrupting provision of power provided to the DC/AC converter when the determined temperature exceeds a preset threshold temperature and resuming the provision of power to the DC/AC converter when the determined temperature is below the preset threshold temperature.

The duration of each temperature step may be at least 10 seconds. The duration of each temperature step may be between 30 seconds and 200 seconds. The duration of each temperature step may be between 40 seconds and 160 seconds. A first temperature step may have a longer duration than subsequent temperature steps. The duration of each temperature step may be predetermined.

The duration of each temperature step may correspond to a predetermined number of user puffs.

The method may further comprise determining one of a conductance value, a current value or a resistance value associated with the susceptor, wherein controlling the power provided to the inductive heating arrangement comprises controlling power the provided to the inductive heating arrangement based on the determined value.

The method may further comprise measuring, at the input side of the DC/AC converter, a DC current drawn from the power source. The conductance value and the resistance value may be determined based on a DC supply voltage of the power source and from the DC current drawn from the power source. The method may further comprise measuring, at the input side of the DC/AC converter, the DC supply voltage of the power source. This is due to the fact that there is a monotonous relationship between the actual conductance (which cannot be determined if the susceptor forms part of the article) of the susceptor and the apparent conductance determined in this way (because the susceptor will impart the conductance of the LCR-circuit (of the DC/AC converter) it will be coupled to, because the majority of the load (R) will be due to the resistance of the susceptor. The conductance is 1/R. Hence, when we in this text refer to the conductance of the susceptor, we are in fact referring to the apparent conductance if the susceptor forms part of a separate aerosol-generating article.

According to another embodiment of the present invention, there is provided an aerosol-generating device comprising: a power source for providing a DC supply voltage and a DC current; and power supply electronics connected to the power source. The power supply electronics may comprise a DC/AC converter and an inductor connected to the DC/AC converter for the generation of an alternating magnetic field, when energized by an alternating current from the DC/AC converter, the inductor being couplable to a susceptor, wherein the susceptor is configured to heat an aerosol-forming substrate; and a controller. The controller may be configured to: perform, during a first heating phase during user operation of the aerosol-generating device for producing an aerosol, a calibration process for measuring one or more calibration values associated with the susceptor; and during a second heating phase during user operation of the aerosol-generating device for producing an aerosol, control power provided to the power supply electronics such that the temperature of the susceptor is adjusted based on the one or more calibration values.

The power supply electronics may be configured to continually supply power from the power source to the inductor, via the DC/AC converter.

The power supply electronics may be configured to supply power from the power source to the inductor, via the DC/AC converter, as a plurality of pulses, each pulse separated by a time interval.

The controller may be configured to control the time interval between each of the plurality of pulses to adjust the temperature of the susceptor.

The controller may be configured to control a length of each pulse of the plurality of pulses to adjust the temperature of the susceptor.

Controlling the power provided to the power supply electronics may comprise adjusting a conductance value associated with the susceptor.

Performing the calibration process may comprise the steps of: (i) controlling the power provided to the power supply electronics to cause an increase of the temperature of the susceptor; (ii) monitoring a current value associated with the susceptor; (iii) interrupting provision of power to the power supply electronics when the current value reaches a maximum, wherein the current value at the maximum corresponds to a second calibration temperature of the susceptor; and (iv) monitoring the current value associated with the susceptor until the current value reaches a minimum, wherein the current value at the minimum corresponds to a first calibration temperature of the susceptor.

Performing the calibration process may further comprise repeating steps i) to iv) when the current value associated with the susceptor reaches the minimum. Performing the calibration process may further comprise, during repetition of steps i) to iv), storing the current value at the maximum as a calibration value of the one or more calibration values and storing the current value at the minimum as a calibration value of the one or more calibration values.

Controlling the power provided to the inductive heating arrangement may comprise maintaining a current value associated with the susceptor between a first current value corresponding to the first calibration temperature and a second current value corresponding to the second calibration temperature.

Performing the calibration process may comprise the steps of: i) controlling the power provided to the inductive heating arrangement to cause an increase of the temperature of the susceptor; ii) monitoring a conductance value associated with the susceptor; iii) interrupting provision of power to the inductive heating arrangement when the conductance value reaches a maximum, wherein the conductance value at the maximum corresponds to a second calibration temperature of the susceptor; and iv) monitoring the conductance value associated with the susceptor until the conductance value reaches a minimum, wherein the conductance value at the minimum corresponds to a first calibration temperature of the susceptor.

Performing the calibration process may further comprise repeating steps i) to iv) when the conductance value associated with the susceptor reaches the minimum. Performing the calibration process may further comprise, during repetition of steps i) to iv), storing the conductance value at the maximum as a calibration value of the one or more calibration values and storing the conductance value at the minimum as a calibration value of the one or more calibration values.

Controlling the power provided to the inductive heating arrangement may comprise maintaining a conductance value associated with the susceptor between a first conductance value corresponding to the first calibration temperature and a second conductance value corresponding to the second calibration temperature.

Performing the calibration process may comprise the steps of: i) controlling the power provided to the inductive heating arrangement to cause an increase of the temperature of the susceptor; ii) monitoring a resistance value associated with the susceptor; iii) interrupting provision of power to the inductive heating arrangement when the resistance value reaches a minimum, wherein the resistance value at the minimum corresponds to a second calibration temperature of the susceptor; and iv) monitoring the resistance value associated with the susceptor until the resistance value reaches a maximum, wherein the resistance value at the maximum corresponds to a first calibration temperature of the susceptor.

Performing the calibration process may further comprise repeating steps i) to iv) when the resistance value associated with the susceptor reaches the maximum.

Performing the calibration process may further comprise, during repetition of steps i) to iv), storing the resistance value at the minimum as a calibration value of the one or more calibration values and storing the resistance value at the maximum as a calibration value of the one or more calibration values.

Controlling the power provided to the inductive heating arrangement may comprise maintaining a resistance value associated with the susceptor between a first resistance value corresponding to the first calibration temperature and a second resistance value corresponding to the second calibration temperature.

The second calibration temperature of the susceptor may correspond to a Curie temperature of a material of the susceptor. The first calibration temperature of the susceptor may correspond to a temperature at maximum permeability of the material of the susceptor.

The first calibration temperature may be between 150 degrees Celsius and 350 degrees Celsius, and the second operating temperature is between 200 degrees Celsius and 400 degrees Celsius. A temperature difference between the first calibration temperature and the second calibration temperature is at least 50 degrees Celsius.

The controller may be further configured to: during the second heating phase, performing the calibration process for measuring one or more calibration values associated with the susceptor in response to detecting one or more of: a predetermined duration of time, a predetermined number of user puffs, and a predetermined voltage value of the power source.

The controller may be further configured to, during the first heating phase, perform a pre-heating process. The pre-heating process may be performed before the calibration process. The pre-heating process may have a predetermined duration. The pre-determined duration of the pre-heating process may be between 10 seconds and 15 seconds.

The pre-heating process may comprise the steps of: i) controlling the power provided to the inductive heating arrangement to cause an increase of the temperature of the susceptor; ii) monitoring at least a current value associated with the susceptor; and iii) interrupting provision of power to the inductive heating arrangement when the current value reaches a minimum.

The preheating process may further comprise, if the current value reaches a minimum before the end of the predetermined duration of the pre-heating process, repeating steps i) to iii) of the pre-heating process until the end of the pre-determined duration of the pre-heating process.

The controller may be further configured to, if the current value associated with the susceptor does not reach a minimum during the predetermined duration of pre-heating process, cease operation of the aerosol-generating device.

The pre-heating process may comprise the steps of: (i) controlling the power provided to the power supply electronics to cause an increase of the temperature of the susceptor; (ii) monitoring a conductance value associated with the susceptor; and (iii) interrupting provision of power to the power supply electronics when the conductance value reaches a minimum.

The controller may be further configured to, if the conductance value associated with the susceptor reaches a minimum before the end of the predetermined duration of the pre-heating process, repeat steps (i) to (iii) of the pre-heating process until the end of the pre-determined duration of the pre-heating process.

The controller is further configured to, if the conductance value associated with the susceptor does not reach a minimum during the predetermined duration of pre-heating process, cease operation of the aerosol-generating device.

The pre-heating process may comprise the steps of: i) controlling the power provided to the inductive heating arrangement to cause an increase of the temperature of the susceptor; ii) monitoring a resistance value associated with the susceptor; and iii) interrupting provision of power to the inductive heating arrangement when the resistance value reaches a maximum.

The pre-heating process may further comprise, if the resistance value reaches a maximum before the end of the predetermined duration of the pre-heating process, repeating steps i) to iii) of the pre-heating process until the end of the pre-determined duration of the pre-heating process.

The controller may be further configured to if the resistance value associated with the susceptor does not reach a maximum during the predetermined duration of pre-heating process, ceasing operation of the aerosol-generating device.

During the pre-heating process, power from the power source may be supplied continuously to the inductor, via the DC/AC converter.

The controller is configured to perform the calibration process in response to detecting the end of the predetermined duration of the pre-heating process.

The controller may be configured to perform the pre-heating process in response to detecting a user input. The user input may correspond to a user activation of the aerosol-generating device.

The controller may be configured to perform the pre-heating process in response to detecting a presence of an aerosol-generating article.

Controlling the power provided to the power supply electronics during the second heating phase may comprise controlling the power to the power supply electronics to cause a step-wise increase of a temperature of the susceptor from a first operating temperature to a second operating temperature. The first operating temperature may be sufficient for the aerosol-forming substrate to form an aerosol.

Controlling the power provided to the inductive heating arrangement to cause the step-wise increase of a temperature of the susceptor enables generation of an aerosol over a sustained period and prevents the reduction of aerosol delivery due to substrate depletion and reduced thermodiffusion over time. Furthermore, the step-wise increase in temperature allows for the heat to spread within the substrate at each step.

The step-wise increase of temperature of the susceptor may comprise at least three temperature steps. Each temperature step may have a duration.

The controller may be configured to maintain the temperature of the susceptor at a predetermined temperature for the duration of each temperature step.

Maintaining the temperature of the susceptor at the predetermined temperature may comprise generating a control signal to interrupt provision of power provided to the DC/AC converter when the determined temperature exceeds a preset threshold temperature and resuming the provision of power to the DC/AC converter when the determined temperature is below the preset threshold temperature.

The predetermined duration of each temperature step may be at least 10 seconds. The duration of each temperature step may be between 30 seconds and 200 seconds. The duration of each temperature step may be between 40 seconds and 160 seconds. A first temperature step may have a longer duration than subsequent temperature steps. The duration of each temperature step may be predetermined. The duration of each temperature step may correspond to a predetermined number of user puffs.

The controller may be further configured to: determine one of a current value, a conductance value or a resistance associated with the susceptor. Controlling the power provided to the power supply electronics may comprise controlling power the provided to the power supply electronics based on the determined value.

The conductance value may be determined from a DC supply voltage of the power source and from a DC current drawn from the power source.

The aerosol-generating device may further comprise: a current sensor configured to measure, at the input side of the DC/AC converter, a DC current drawn from the power source.

The conductance value associated with the susceptor may be determined from a DC supply voltage of the power source and from the DC current drawn from the power source.

The aerosol-generating device may further comprise a voltage sensor configured to measure, at the input side of the DC/AC converter, the DC supply voltage of the power source.

The power supply electronics may further comprise a matching network for matching the impedance of the inductor to that of the susceptor.

The aerosol-generating device may further comprise a housing having a cavity configured to removably receive an aerosol-generating article. The aerosol-generating article may comprise the aerosol-forming substrate and the susceptor.

According to another embodiment of the present invention, there is provided an aerosol-generating system. The aerosol-generating system may comprise the aerosol-generating device described above. The aerosol-generating system may further comprise an aerosol-generating article. The aerosol-generating article may comprises the aerosol-forming substrate and the susceptor.

The susceptor may comprise a first layer consisting of a first material and a second layer consisting of a second material. The first material may be disposed in physical contact with the second material. The first material may be one of aluminum, iron, and stainless steel, and wherein the second material is nickel or a nickel alloy. The first material may have a first Curie temperature and the second material may have a second Curie temperature. The second Curie temperature may be lower than the first Curie temperature. The second calibration temperature may correspond to the second Curie temperature of the second susceptor material.

As used herein, the term “aerosol-generating device” refers to a device that interacts with an aerosol-forming substrate to generate an aerosol. An aerosol-generating device may interact with one or both of an aerosol-generating article comprising an aerosol-forming substrate, and a cartridge comprising an aerosol-forming substrate. In some examples, the aerosol-generating device may heat the aerosol-forming substrate to facilitate release of volatile compounds from the substrate. An electrically operated aerosol-generating device may comprise an atomizer, such as an electric heater, to heat the aerosol-forming substrate to form an aerosol.

As used herein, the term “aerosol-generating system” refers to the combination of an aerosol-generating device with an aerosol-forming substrate. When the aerosol-forming substrate forms part of an aerosol-generating article, the aerosol-generating system refers to the combination of the aerosol-generating device with the aerosol-generating article. In the aerosol-generating system, the aerosol-forming substrate and the aerosol-generating device cooperate to generate an aerosol.

As used herein, the term “aerosol-forming substrate” refers to a substrate capable of releasing volatile compounds that can form an aerosol. The volatile compounds may be released by heating or combusting the aerosol-forming substrate. As an alternative to heating or combustion, in some cases, volatile compounds may be released by a chemical reaction or by a mechanical stimulus, such as ultrasound. The aerosol-forming substrate may be solid or may comprise both solid and liquid components. An aerosol-forming substrate may be part of an aerosol-generating article.

As used herein, the term “aerosol-generating article” refers to an article comprising an aerosol-forming substrate that is capable of releasing volatile compounds that can form an aerosol. An aerosol-generating article may be disposable. An aerosol-generating article comprising an aerosol-forming substrate comprising tobacco may be referred to herein as a tobacco stick.

An aerosol-forming substrate may comprise nicotine. An aerosol-forming substrate may comprise tobacco, for example may comprise a tobacco-containing material containing volatile tobacco flavor compounds, which are released from the aerosol-forming substrate upon heating. In preferred embodiments an aerosol-forming substrate may comprise homogenized tobacco material, for example cast leaf tobacco. The aerosol-forming substrate may comprise both solid and liquid components. The aerosol-forming substrate may comprise a tobacco-containing material containing volatile tobacco flavor compounds, which are released from the substrate upon heating. The aerosol-forming substrate may comprise a non-tobacco material. The aerosol-forming substrate may further comprise an aerosol former. Examples of suitable aerosol formers are glycerin and propylene glycol.

As used herein, “aerosol-cooling element” refers to a component of an aerosol-generating article located downstream of the aerosol-forming substrate such that, in use, an aerosol formed by volatile compounds released from the aerosol-forming substrate passes through and is cooled by the aerosol cooling element before being inhaled by a user. An aerosol cooling element has a large surface area, but causes a low pressure drop. Filters and other mouthpieces that produce a high pressure drop, for example filters formed from bundles of fibers, are not considered to be aerosol-cooling elements. Chambers and cavities within an aerosol-generating article are not considered to be aerosol cooling elements.

As used herein, the term “mouthpiece” refers to a portion of an aerosol-generating article, an aerosol-generating device or an aerosol-generating system that is placed into a user's mouth in order to directly inhale an aerosol.

As used herein, the term “susceptor” refers to an element comprising a material that is capable of converting the energy of a magnetic field into heat. When a susceptor is located in an alternating magnetic field, the susceptor is heated. Heating of the susceptor may be the result of at least one of hysteresis losses and eddy currents induced in the susceptor, depending on the electrical and magnetic properties of the susceptor material.

As used herein when referring to an aerosol-generating device, the terms “upstream” and “front”, and “downstream” and “rear”, are used to describe the relative positions of components, or portions of components, of the aerosol-generating device in relation to the direction in which air flows through the aerosol-generating device during use thereof. Aerosol-generating devices according to the invention comprise a proximal end through which, in use, an aerosol exits the device. The proximal end of the aerosol-generating device may also be referred to as the mouth end or the downstream end. The mouth end is downstream of the distal end. The distal end of the aerosol-generating article may also be referred to as the upstream end. Components, or portions of components, of the aerosol-generating device may be described as being upstream or downstream of one another based on their relative positions with respect to the airflow path of the aerosol-generating device.

As used herein when referring to an aerosol-generating article, the terms “upstream” and “front”, and “downstream” and “rear”, are used to describe the relative positions of components, or portions of components, of the aerosol-generating article in relation to the direction in which air flows through the aerosol-generating article during use thereof. Aerosol-generating articles according to the invention comprise a proximal end through which, in use, an aerosol exits the article. The proximal end of the aerosol-generating article may also be referred to as the mouth end or the downstream end. The mouth end is downstream of the distal end. The distal end of the aerosol-generating article may also be referred to as the upstream end. Components, or portions of components, of the aerosol-generating article may be described as being upstream or downstream of one another based on their relative positions between the proximal end of the aerosol-generating article and the distal end of the aerosol-generating article. The front of a component, or portion of a component, of the aerosol-generating article is the portion at the end closest to the upstream end of the aerosol-generating article. The rear of a component, or portion of a component, of the aerosol-generating article is the portion at the end closest to the downstream end of the aerosol-generating article.

As used herein, the term “inductively couple” refers to the heating of a susceptor when penetrated by an alternating magnetic field. The heating may be caused by the generation of eddy currents in the susceptor. The heating may be caused by magnetic hysteresis losses.

As used herein, the term “puff” means the action of a user drawing an aerosol into their body through their mouth or nose.

The invention is defined in the claims. However, below there is provided a non-exhaustive list of non-limiting examples. Any one or more of the features of these examples may be combined with any one or more features of another example, embodiment, or aspect described herein.

Example Ex1: A method for controlling aerosol production in an aerosol-generating device, the device comprising an inductive heating arrangement and a power source for providing power to the inductive heating arrangement, and the method comprising: performing, during a first heating phase during user operation of the aerosol-generating device for producing an aerosol, a calibration process for measuring one or more calibration values associated with a susceptor inductively coupled to the inductive heating arrangement, wherein the susceptor is configured to heat an aerosol-forming substrate; and during a second heating phase during user operation of the aerosol-generating device for producing an aerosol, controlling power provided to the inductive heating arrangement such that the temperature of the susceptor is adjusted based on the one or more calibration values.

Example Ex2. The method according to example Ex1, wherein the inductive heating arrangement comprises a DC/AC converter and an inductor connected to the DC/AC converter, and wherein the susceptor is arranged to inductively couple to the inductor.

Example Ex3. The method according to example Ex2, wherein power from the power source is supplied continually to the inductor, via the DC/AC converter.

Example Ex4. The method according to example Ex2 or Ex3, wherein power from the power source is supplied to the inductor, via the DC/AC converter, as a plurality of pulses, each pulse separated by a time interval.

Example Ex5. The method according to example Ex4, wherein adjusting the temperature of the susceptor comprises controlling the time interval between each of the plurality of pulses.

Example Ex6. The method according to example Ex4, wherein adjusting the temperature of the susceptor comprises controlling a length of each pulse of the plurality of pulses.

Example Ex7. The method according to any of examples Ex1 to Ex6, wherein controlling the power provided to the inductive heating arrangement comprises adjusting one of a current value, a conductance value and a resistance value associated with the susceptor.

Example Ex8. The method according to any of examples Ex1 to Ex7, wherein performing the calibration process comprises the steps of: (i) controlling the power provided to the inductive heating arrangement to cause an increase of the temperature of the susceptor; (ii) monitoring a at least a current value associated with the susceptor; (iii) interrupting provision of power to the inductive heating arrangement when the current value reaches a maximum, wherein the current value at the maximum corresponds to a second calibration temperature of the susceptor; and (iv) monitoring the current value associated with the susceptor until the current value reaches a minimum, wherein the current value at the minimum corresponds to a first calibration temperature of the susceptor.

Example Ex9: The method according to example Ex8, wherein performing the calibration process further comprises repeating steps i) to iv) when the current value associated with the susceptor reaches the minimum.

Example Ex10: The method according to example Ex9, wherein performing the calibration process further comprises, during repetition of steps i) to iv), storing the current value at the maximum as a calibration value of the one or more calibration values and storing the current value at the minimum as a calibration value of the one or more calibration values.

Example Ex11: The method according to any of examples Ex8 to Ex10, wherein controlling the power provided to the inductive heating arrangement comprises maintaining a current value associated with the susceptor between a first current value corresponding to the first calibration temperature and a second current value corresponding to the second calibration temperature.

Example Ex12: The method according to any of examples Ex1 to Ex7, wherein performing the calibration process comprises the steps of: i) controlling the power provided to the inductive heating arrangement to cause an increase of the temperature of the susceptor; ii) monitoring a conductance value associated with the susceptor; iii) interrupting provision of power to the inductive heating arrangement when the conductance value reaches a maximum, wherein the conductance value at the maximum corresponds to a second calibration temperature of the susceptor; and iv) monitoring the conductance value associated with the susceptor until the conductance value reaches a minimum, wherein the conductance value at the minimum corresponds to a first calibration temperature of the susceptor.

Example Ex13: The method according to example Ex12, wherein performing the calibration process further comprises repeating steps i) to iv) when the conductance value associated with the susceptor reaches the minimum.

Example Ex14: The method according to example Ex13, wherein performing the calibration process further comprises, during repetition of steps i) to iv), storing the conductance value at the maximum as a calibration value of the one or more calibration values and storing the conductance value at the minimum as a calibration value of the one or more calibration values.

Example Ex15: The method according to any of example Ex12 to Ex14, wherein controlling the power provided to the inductive heating arrangement comprises maintaining a conductance value associated with the susceptor between a first conductance value corresponding to the first calibration temperature and a second conductance value corresponding to the second calibration temperature.

Example Ex16. The method according to any of examples Ex1 to Ex7, wherein performing the calibration process comprises the steps of: i) controlling the power provided to the inductive heating arrangement to cause an increase of the temperature of the susceptor; ii) monitoring a resistance value associated with the susceptor; iii) interrupting provision of power to the inductive heating arrangement when the resistance value reaches a minimum, wherein the resistance value at the minimum corresponds to a second calibration temperature of the susceptor; and iv) monitoring the resistance value associated with the susceptor until the resistance value reaches a maximum, wherein the resistance value at the maximum corresponds to a first calibration temperature of the susceptor.

Example Ex17: The method according to example Ex16, wherein performing the calibration process further comprises repeating steps i) to iv) when the resistance value associated with the susceptor reaches the maximum.

Example Ex18: The method according to example Ex17, wherein performing the calibration process further comprises, during repetition of steps i) to iv), storing the resistance value at the minimum as a calibration value of the one or more calibration values and storing the resistance value at the maximum as a calibration value of the one or more calibration values.

Example Ex19: The method according to any of examples Ex16 to Ex18, wherein controlling the power provided to the inductive heating arrangement comprises maintaining a resistance value associated with the susceptor between a first resistance value corresponding to the first calibration temperature and a second resistance value corresponding to the second calibration temperature.

Example Ex20. The method according to any of examples Ex 8 to Ex19, wherein the second calibration temperature of the susceptor corresponds to a Curie temperature of a material of the susceptor, and wherein the first calibration temperature of the susceptor corresponds to a temperature at maximum permeability of the material of the susceptor.

Example Ex21. The method according to any of examples Ex8 or Ex19, wherein the susceptor comprises a first susceptor material having a first Curie temperature and and a second susceptor material having a second Curie temperature, wherein the second Curie temperature is lower than the first Curie temperature, and wherein the second calibration temperature corresponds to the second Curie temperature of the second susceptor material.

Example Ex22. The method according to any of examples Ex8 to Ex21, wherein the first calibration temperature is between 150 degrees Celsius and 350 degrees Celsius, and the second calibration temperature is between 200 degrees Celsius and 400 degrees Celsius, and wherein a temperature difference between the first calibration temperature and the second calibration temperature is at least 50 degrees Celsius.

Example Ex23. The method according to any of examples Ex1 to Ex22, further comprising: during the second heating phase, performing the calibration process for measuring one or more calibration values associated with the susceptor in response to detecting one or more of: a predetermined duration of time, a predetermined number of user puffs, and a predetermined voltage value of the power source.

Example Ex24: The method according to any of examples Ex1 to Ex23, further comprising, during the first heating phase, performing a pre-heating process, wherein the pre-heating process is performed before the calibration process, and wherein the pre-heating process has a predetermined duration.

Example Ex25: The method according to example Ex24, wherein the pre-determined duration of the pre-heating process is between 10 seconds and 15 seconds.

Example Ex26: The method according to example Ex24 or Ex25, wherein the pre-heating process comprises the steps of: i) controlling the power provided to the inductive heating arrangement to cause an increase of the temperature of the susceptor; ii) monitoring at least a current value associated with the susceptor; and iii) interrupting provision of power to the inductive heating arrangement when the current value reaches a minimum.

Example Ex27: The method according to example Ex26, further comprising, if the current value reaches a minimum before the end of the predetermined duration of the pre-heating process, repeating steps i) to iii) of the pre-heating process until the end of the pre-determined duration of the pre-heating process

Example Ex28: The method according to example Ex27, further comprising: if the current value associated with the susceptor does not reach a minimum during the predetermined duration of pre-heating process, ceasing operation of the aerosol-generating device.

Example Ex29: The method according to example Ex24 or Ex25, wherein the pre-heating process comprises the steps of: (i) controlling the power provided to the inductive heating arrangement to cause an increase of the temperature of the susceptor; (ii) monitoring a conductance value associated with the susceptor; and (iii) interrupting provision of power to the inductive heating arrangement when the conductance value reaches a minimum.

Example Ex30. The method according to example Ex29, further comprising, if the conductance value reaches a minimum before the end of the predetermined duration of the pre-heating process, repeating steps (i) to (iii) of the pre-heating process until the end of the pre-determined duration of the pre-heating process

Example Ex31. The method according to example Ex30, further comprising: if the conductance value associated with the susceptor does not reach a minimum during the predetermined duration of pre-heating process, ceasing operation of the aerosol-generating device.

Example Ex32: The method according to example Ex20 or Ex21, wherein the pre-heating process comprises the steps of: i) controlling the power provided to the inductive heating arrangement to cause an increase of the temperature of the susceptor; ii) monitoring a resistance value associated with the susceptor; and iii) interrupting provision of power to the inductive heating arrangement when the resistance value reaches a maximum.

Example Ex33: The method according to example Ex32, further comprising, if the resistance value reaches a maximum before the end of the predetermined duration of the pre-heating process, repeating steps i) to iii) of the pre-heating process until the end of the pre-determined duration of the pre-heating process.

Example Ex34: The method according to example Ex33, further comprising: if the resistance value associated with the susceptor does not reach a maximum during the predetermined duration of pre-heating process, ceasing operation of the aerosol-generating device.

Example Ex35. The method according to any of examples Ex20 to Ex34, wherein, during the pre-heating process, power from the power source is supplied continuously to the inductor, via the DC/AC converter.

Example Ex36. The method according to any of examples Ex20 to Ex35, wherein the calibration process is performed in response to detecting the end of the predetermined duration of the pre-heating process.

Example Ex37. The method according to any of examples Ex20 to Ex36, wherein the pre-heating process is performed in response to detecting a user input.

Example Ex38. The method according to example Ex37, wherein the user input corresponds to a user activation of the aerosol-generating device.

Example Ex39. The method according to any of examples Ex20 to Ex38, wherein the aerosol-generating device is configured to receive the aerosol-generating article, wherein the aerosol-generating article comprises the susceptor and the aerosol-forming substrate, and wherein the pre-heating process is performed in response to detecting a presence of the aerosol-generating article.

Example Ex40. The method according to any of examples Ex1 to Ex39, wherein controlling the power provided to the inductive heating arrangement during the second heating phase comprises controlling the power to the inductive heating arrangement to cause a step-wise increase of a temperature of the susceptor from a first operating temperature to a second operating temperature.

Example Ex41. The method according to example Ex40, wherein the first operating temperature is sufficient for the aerosol-forming substrate to form an aerosol.

Example Ex42. The method according to example Ex40 or Ex41, wherein the step-wise increase of the temperature of the susceptor comprises at least three consecutive temperature steps, each temperature step having a duration.

Example Ex43. The method according to example Ex42, wherein, for the duration of each temperature step, the temperature of the susceptor is maintained at a predetermined temperature.

Example Ex44. The method according to example Ex43, wherein maintaining the temperature of the susceptor at the predetermined temperature comprises interrupting provision of power provided to the DC/AC converter when the determined temperature exceeds a preset threshold temperature and resuming the provision of power to the DC/AC converter when the determined temperature is below the preset threshold temperature.

Example Ex45. The method according to any of examples Ex42 to Ex44, wherein the duration of each temperature step is at least 10 seconds.

Example Ex46. The method according to any of examples Ex42 to Ex44, wherein the duration of each temperature step is between 30 seconds and 200 seconds.

Example Ex47. The method according to any of examples Ex42 to Ex44, wherein the duration of each temperature step is between 40 seconds and 160 seconds.

Example Ex48. The method according to any of claims 42 to 47, wherein the duration of each temperature step is predetermined.

Example Ex49. The method according to any of examples Ex42 to Ex44, wherein the predetermined duration of each temperature step corresponds to a predetermined number of user puffs.

Example Ex50. The method according to any of examples Ex43 to Ex49, wherein a first temperature step has a longer duration than subsequent temperature steps.

Example Ex51. The method according to any of the examples Ex1 to Ex50, further comprising: determining one of a current value, a conductance value and a resistance value associated with the susceptor, wherein controlling the power provided to the inductive heating arrangement comprises controlling the power provided to the inductive heating arrangement based on the determined value.

Example Ex52. The method according to any of examples Ex7 to Ex51, further comprising measuring, at the input side of the DC/AC converter, a DC current drawn from the power source, wherein the conductance value and the resistance value are determined based on a DC supply voltage of the power source and from the DC current drawn from the power source.

Example Ex53. The method according to example Ex52, further comprising measuring, at the input side of the DC/AC converter, the DC supply voltage of the power source.

Example Ex54. An aerosol-generating device comprising: a power source for providing a DC supply voltage and a DC current; power supply electronics connected to the power source, the power supply electronics comprising: a DC/AC converter and an inductor connected to the DC/AC converter for the generation of an alternating magnetic field, when energized by an alternating current from the DC/AC converter, the inductor being couplable to a susceptor, wherein the susceptor is configured to heat an aerosol-forming substrate; and a controller configured to: perform, during a first heating phase during user operation of the aerosol-generating device for producing an aerosol, a calibration process for measuring one or more calibration values associated with the susceptor; and during a second heating phase during user operation of the aerosol-generating device for producing an aerosol, control power provided to the power supply electronics such that the temperature of the susceptor is adjusted based on the one or more calibration values.

Example Ex55. The aerosol-generating device according to example Ex54, wherein the power supply electronics are configured to continually supply power from the power source to the inductor, via the DC/AC converter.

Example Ex56. The aerosol-generating device according to example Ex54 or Ex55, wherein the power supply electronics are configured to supply power from the power source to the inductor, via the DC/AC converter, as a plurality of pulses, each pulse separated by a time interval.

Example Ex57. The aerosol-generating device according to example Ex56, wherein the controller is configured to control the time interval between each of the plurality of pulses to adjust the temperature of the susceptor.

Example Ex58. The aerosol-generating device according to example Ex56, wherein the controller is configured to control a length of each pulse of the plurality of pulses to adjust the temperature of the susceptor.

Example Ex59. The aerosol-generating device according to any of examples Ex54 to Ex58, wherein controlling the power provided to the power supply electronics comprises adjusting one of a current value, a conductance value or a resistance value associated with the susceptor.

Example Ex60. The aerosol-generating device according to any of examples Ex54 to Ex59, wherein performing the calibration process comprises the steps of: (i) controlling the power provided to the power supply electronics to cause an increase of the temperature of the susceptor; (ii) monitoring a current value associated with the susceptor; (iii) interrupting provision of power to the power supply electronics when the current value reaches a maximum, wherein the current value at the maximum corresponds to a second calibration temperature of the susceptor; and (iv) monitoring the current value associated with the susceptor until the current value reaches a minimum, wherein the current value at the minimum corresponds to a first calibration temperature of the susceptor.

Example Ex61. The aerosol-generating device according to example Ex60, wherein performing the calibration process further comprises repeating steps i) to iv) when the current value associated with the susceptor reaches the minimum.

Example Ex62. The aerosol-generating device according to example Ex61, wherein performing the calibration process further comprises, during repetition of steps i) to iv), storing the current value at the maximum as a calibration value of the one or more calibration values and storing the current value at the minimum as a calibration value of the one or more calibration values.

Example Ex63. The aerosol-generating device according to any of examples Ex60 to Ex62, wherein controlling the power provided to the inductive heating arrangement comprises maintaining a current value associated with the susceptor between a first current value corresponding to the first calibration temperature and a second current value corresponding to the second calibration temperature.

Example Ex64. The aerosol-generating device according to any of examples Ex54 to Ex58, wherein performing the calibration process comprises the steps of: i) controlling the power provided to the inductive heating arrangement to cause an increase of the temperature of the susceptor; ii) monitoring a conductance value associated with the susceptor; iii) interrupting provision of power to the inductive heating arrangement when the conductance value reaches a maximum, wherein the conductance value at the maximum corresponds to a second calibration temperature of the susceptor; and iv) monitoring the conductance value associated with the susceptor until the conductance value reaches a minimum, wherein the conductance value at the minimum corresponds to a first calibration temperature of the susceptor.

Example Ex65. The aerosol-generating device according to example Ex64, wherein performing the calibration process further comprises repeating steps i) to iv) when the conductance value associated with the susceptor reaches the minimum.

Example Ex66. The aerosol-generating device according to example Ex65, wherein performing the calibration process further comprises, during repetition of steps i) to iv), storing the conductance value at the maximum as a calibration value of the one or more calibration values and storing the conductance value at the minimum as a calibration value of the one or more calibration values.

Example Ex67. The aerosol-generating device according to any of examples Ex64 to Ex66, wherein controlling the power provided to the inductive heating arrangement comprises maintaining a conductance value associated with the susceptor between a first conductance value corresponding to the first calibration temperature and a second conductance value corresponding to the second calibration temperature.

Example Ex68. The aerosol-generating device according to any of examples Ex54 to Ex58, wherein performing the calibration process comprises the steps of: i) controlling the power provided to the inductive heating arrangement to cause an increase of the temperature of the susceptor; ii) monitoring a resistance value associated with the susceptor; iii) interrupting provision of power to the inductive heating arrangement when the resistance value reaches a minimum, wherein the resistance value at the minimum corresponds to a second calibration temperature of the susceptor; and iv) monitoring the resistance value associated with the susceptor until the resistance value reaches a maximum, wherein the resistance value at the maximum corresponds to a first calibration temperature of the susceptor.

Example Ex69. The aerosol-generating device according to example Ex68, wherein performing the calibration process further comprises repeating steps i) to iv) when the resistance value associated with the susceptor reaches the maximum.

Example Ex70. The aerosol-generating device according to example Ex69, wherein performing the calibration process further comprises, during repetition of steps i) to iv), storing the resistance value at the minimum as a calibration value of the one or more calibration values and storing the resistance value at the maximum as a calibration value of the one or more calibration values.

Example Ex71. The aerosol-generating device according to any of examples Ex68 to Ex70, wherein controlling the power provided to the inductive heating arrangement comprises maintaining a resistance value associated with the susceptor between a first resistance value corresponding to the first calibration temperature and a second resistance value corresponding to the second calibration temperature.

Example Ex72. The aerosol-generating device according to any of examples Ex54 to 71, wherein the second calibration temperature of a material of the susceptor corresponds to a Curie temperature of the susceptor.

Example Ex73: The aerosol-generating device according to example Ex72, wherein the first calibration temperature of the susceptor corresponds to a temperature at maximum permeability of the material of the susceptor.

Example Ex74. The aerosol-generating device according to any of examples Ex54 to Ex71, wherein the first calibration temperature is between 150 degrees Celsius and 350 degrees Celsius, and the second calibration temperature is between 200 degrees Celsius and 400 degrees Celsius, and wherein a temperature difference between the first calibration temperature and the second calibration temperature is at least 50 degrees Celsius.

Example Ex75. The aerosol-generating device according to examples Ex54 to Ex74, wherein the controller is further configured to: during the second heating phase, performing the calibration process for measuring one or more calibration values associated with the susceptor in response to detecting one or more of: a predetermined duration of time, a predetermined number of user puffs, and a predetermined voltage value of the power source.

Example Ex76. The aerosol-generating device according to any of examples Ex54 to Ex75, wherein the controller is further configured to, during the first heating phase, perform a pre-heating process, wherein the pre-heating process is performed before the calibration process, and wherein the pre-heating process has a predetermined duration.

Example Ex77. The aerosol-generating device according to example Ex76, wherein the pre-determined duration of the pre-heating process is between 10 seconds and 15 seconds.

Example Ex78. The aerosol-generating device according to example Ex76 or Ex77, wherein the pre-heating process comprises the steps of: i) controlling the power provided to the inductive heating arrangement to cause an increase of the temperature of the susceptor; ii) monitoring at least a current value associated with the susceptor; and iii) interrupting provision of power to the inductive heating arrangement when the current value reaches a minimum.

Example Ex79. The aerosol-generating device according to example Ex26, wherein the preheating process further comprises, if the current value reaches a minimum before the end of the predetermined duration of the pre-heating process, repeating steps i) to iii) of the pre-heating process until the end of the pre-determined duration of the pre-heating process.

Example Ex80. The aerosol-generating device according to example Ex27, wherein the controller is further configured to, if the current value associated with the susceptor does not reach a minimum during the predetermined duration of pre-heating process, cease operation of the aerosol-generating device.

Example Ex81. The aerosol-generating device according to example Ex76 or 77, wherein the pre-heating process comprises the steps of: (i) controlling the power provided to the power supply electronics to cause an increase of the temperature of the susceptor; (ii) monitoring a conductance value associated with the susceptor; and (iii) interrupting provision of power to the power supply electronics when the conductance value reaches a minimum.

Example Ex82. The aerosol-generating device according to example Ex81, wherein the controller is further configured to, if the conductance value reaches a minimum before the end of the predetermined duration of the pre-heating process, repeat steps (i) to (iii) of the pre-heating process until the end of the pre-determined duration of the pre-heating process.

Example Ex83. The aerosol-generating device according to example Ex81 or Ex82, wherein the controller is further configured to, if the conductance value associated with the susceptor does not reach a minimum during the predetermined duration of pre-heating process, cease operation of the aerosol-generating device.

Example Ex84. The aerosol-generating device according to example Ex76 or Ex77, wherein the pre-heating process comprises the steps of: i) controlling the power provided to the inductive heating arrangement to cause an increase of the temperature of the susceptor; ii) monitoring a resistance value associated with the susceptor; and iii) interrupting provision of power to the inductive heating arrangement when the resistance value reaches a maximum.

Example Ex85. The aerosol-generating device according to example Ex84, wherein the pre-heating process further comprises, if the resistance value reaches a maximum before the end of the predetermined duration of the pre-heating process, repeating steps i) to iii) of the pre-heating process until the end of the pre-determined duration of the pre-heating process.

Example 86. The aerosol-generating device according to example Ex85, wherein the controller is further configured to if the resistance value associated with the susceptor does not reach a maximum during the predetermined duration of pre-heating process, ceasing operation of the aerosol-generating device.

Example Ex87. The aerosol-generating device according to any of examples Ex76 to Ex86, wherein, during the pre-heating process, power from the power source is supplied continuously to the inductor, via the DC/AC converter.

Example Ex88. The aerosol-generating device according to any of examples Ex76 to Ex87, wherein the controller is configured to perform the calibration process in response to detecting the end of the predetermined duration of the pre-heating process.

Example Ex89. The aerosol-generating device according to any of examples Ex76 to Ex87, wherein the controller is configured to perform the pre-heating process in response to detecting a user input.

Example Ex90. The aerosol-generating device according to example Ex89, wherein the user input corresponds to a user activation of the aerosol-generating device.

Example Ex91. The aerosol-generating device according to any of examples Ex79 to Ex87, wherein the controller is configured to perform the pre-heating process in response to detecting a presence of an aerosol-generating article.

Example Ex92. The aerosol-generating device according to any of examples Ex54 to 91, wherein controlling the power provided to the power supply electronics during the second heating phase comprises controlling the power to the power supply electronics to cause a step-wise increase of a temperature of the susceptor from a first operating temperature to a second operating temperature.

Example Ex93. The aerosol-generating device according to example Ex92, wherein the first operating temperature is sufficient for the aerosol-forming substrate to form an aerosol.

Example Ex94. The aerosol-generating device according to example Ex92 or 93, wherein the step-wise increase of temperature of the susceptor comprises at least three consecutive temperature steps, each temperature step having a duration.

Example Ex95. The aerosol-generating device according to example Ex94, wherein, the controller is configured to maintain the temperature of the susceptor at a predetermined temperature for the duration of each temperature step.

Example Ex96. The aerosol-generating device according to example Ex95, wherein maintaining the temperature of the susceptor at the predetermined temperature comprises generating a control signal to interrupt provision of power provided to the DC/AC converter when the determined temperature exceeds a preset threshold temperature and resuming the provision of power to the DC/AC converter when the determined temperature is below the preset threshold temperature.

Example Ex97. The aerosol-generating device according to any of examples Ex94 to Ex96, wherein the duration of each temperature step is at least 10 seconds.

Example Ex98. The aerosol-generating device according to any of examples Ex94 to Ex96, wherein the duration of each temperature step is between 30 seconds and 200 seconds.

Example Ex99. The aerosol-generating device according to any of examples Ex94 to Ex96, wherein the duration of each temperature step is between 40 seconds and 160 seconds.

Example Ex100. The aerosol-generating device according to any of examples Ex94 to Ex99, wherein the duration of each temperature step is predetermined.

Example Ex101. The aerosol-generating device according to any of examples Ex94 to Ex96, wherein the duration of each temperature step corresponds to a predetermined number of user puffs.

Example Ex102. The aerosol-generating device according to any of examples Ex94 to Ex101, wherein a first temperature step has a longer duration than subsequent temperature steps.

Example Ex103. The aerosol-generating device according to any of the examples Ex54 to Ex102, wherein the controller is further configured to: determining one of a current value, a conductance value or a resistance value associated with the susceptor, and wherein controlling the power provided to the power supply electronics comprises controlling power the provided to the power supply electronics based on the determined value.

Example Ex104. The aerosol-generating device according to any of examples Ex56 to Ex103, wherein the conductance value or the resistance value is determined from a DC supply voltage of the power source and from a DC current drawn from the power source.

Example Ex105. The aerosol-generating device according to any of examples Ex59 to Ex104, further comprising: a current sensor configured to measure, at the input side of the DC/AC converter, a DC current drawn from the power source, wherein the conductance value or the resistance value associated with the susceptor is determined from a DC supply voltage of the power source and from the DC current drawn from the power source.

Example Ex106. The aerosol-generating device according to example Ex105, further comprising a voltage sensor configured to measure, at the input side of the DC/AC converter, the DC supply voltage of the power source.

Example Ex107. The aerosol-generating device according to any of examples Ex56 to Ex106, wherein the power supply electronics further comprises a matching network for matching the impedance of the inductor to that of the susceptor.

Example Ex108. The aerosol-generating device according to any of examples Ex56 to Ex107, further comprising a housing having a cavity configured to removably receive an aerosol-generating article, wherein the aerosol-generating article comprises the aerosol-forming substrate and the susceptor.

Example Ex109. An aerosol-generating system, comprising: the aerosol-generating device of one of examples Ex56 to Ex108; and an aerosol-generating article, wherein the aerosol-generating article comprises the aerosol-forming substrate and the susceptor.

Example Ex110. The aerosol-generating system according to example Ex109, wherein the susceptor comprises a first layer consisting of a first material and a second layer consisting of a second material, wherein the first material is disposed in physical contact with the second material.

Example Ex111. The aerosol-generating system according to example Ex110, wherein the first material is one of aluminum, iron, and stainless steel, and wherein the second material is nickel or a nickel alloy.

Example Ex112. The aerosol-generating system according to example Ex109 or Ex110, wherein the first material has a first Curie temperature and the second material has a second Curie temperature, wherein the second Curie temperature is lower than the first Curie temperature.

Example Ex113. The aerosol-generating system according to example Ex112, wherein the second calibration temperature corresponds to the second Curie temperature of the second susceptor material.

Examples will now be further described with reference to the figures in which:

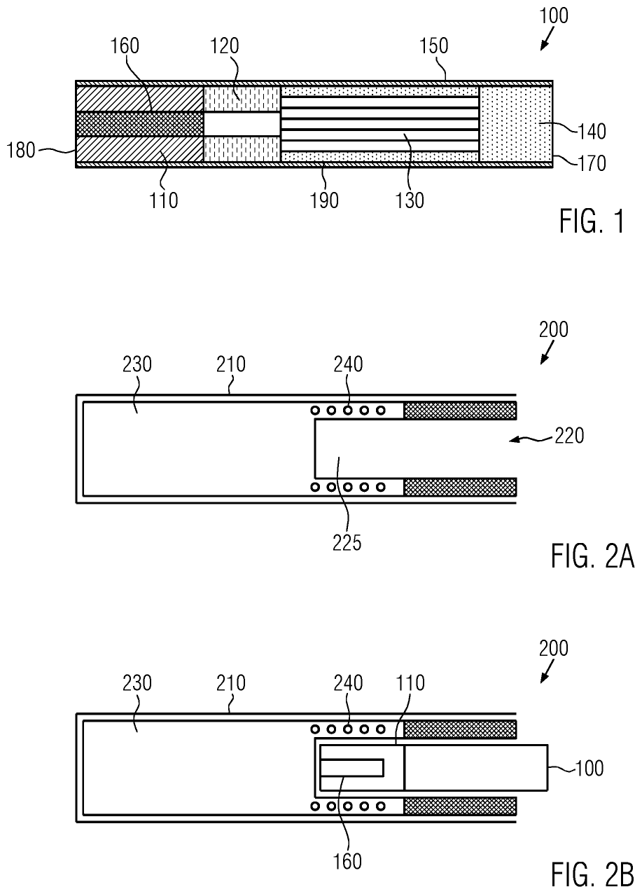

FIG. 1 shows a schematic cross-sectional illustration of an aerosol-generating article;

FIG. 2A shows a schematic cross-sectional illustration of an aerosol-generating device for use with the aerosol-generating article illustrated in FIG. 1;

FIG. 2B shows a schematic cross-sectional illustration of the aerosol-generating device in engagement with the aerosol-generating article illustrated in FIG. 1;

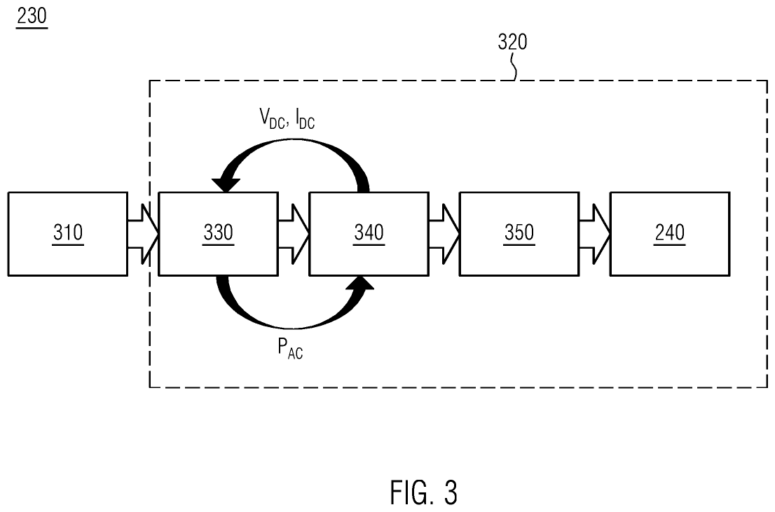

FIG. 3 is a block diagram showing an inductive heating device of the aerosol-generating device described in relation to FIG. 2;

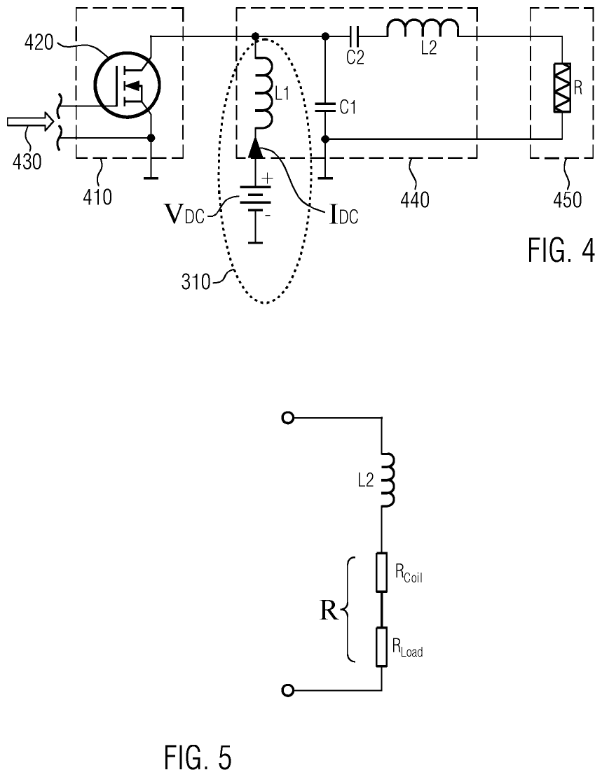

FIG. 4 is a schematic diagram showing electronic components of the inductive heating device described in relation to FIG. 3;

FIG. 5 is a schematic diagram on an inductor of an LC load network of the inductive heating device described in relation to FIG. 4;

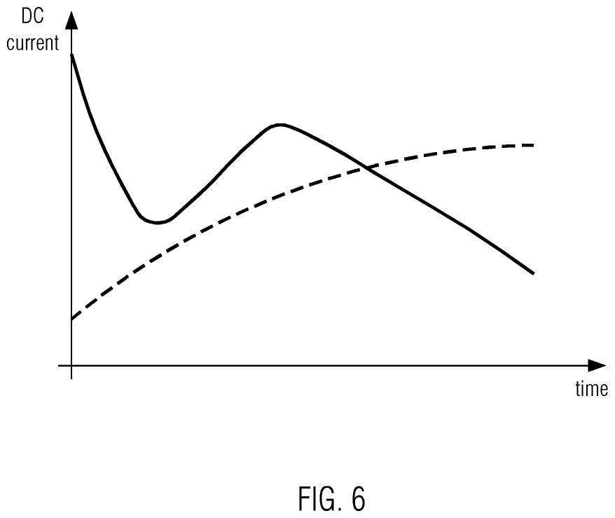

FIG. 6 is a graph of DC current vs. time illustrating the remotely detectable current changes that occur when a susceptor material undergoes a phase transition associated with its Curie point;

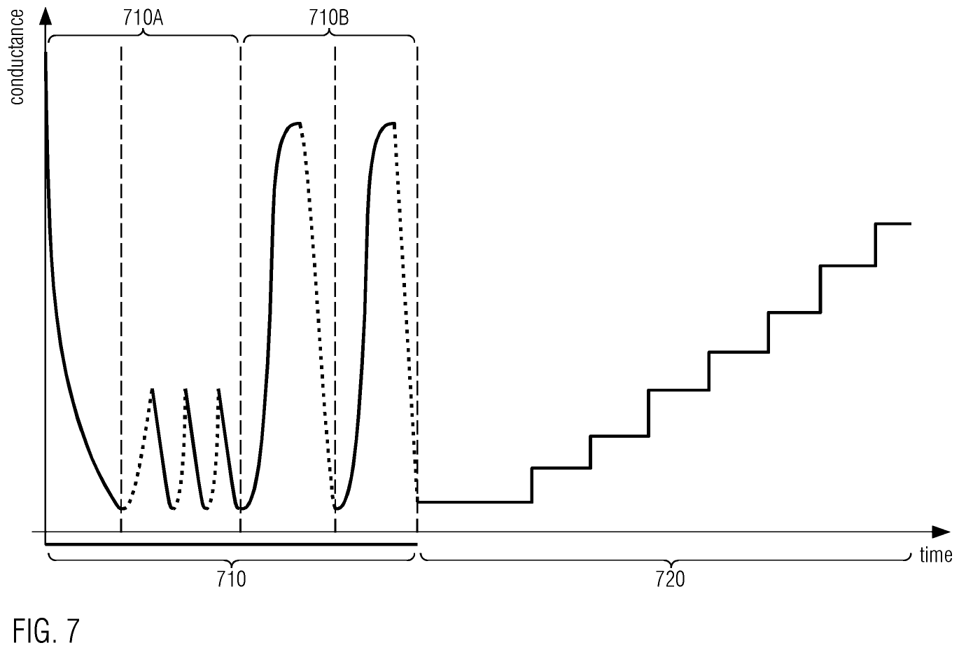

FIG. 7 illustrates a temperature profile of the susceptor during operation of the aerosol-generating device; and

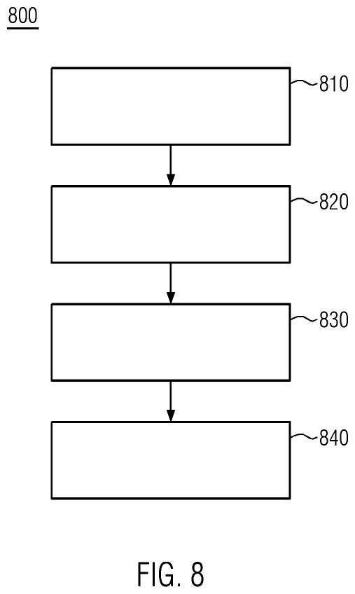

FIG. 8 is a flow diagram showing a method for controlling aerosol-production in the aerosol-generating device of FIG. 2.

FIG. 1 illustrates an aerosol-generating article 100. The aerosol-generating article 100 comprises four elements arranged in coaxial alignment: an aerosol-forming substrate 110, a support element 120, an aerosol-cooling element 130, and a mouthpiece 140. Each of these four elements is a substantially cylindrical element, each having substantially the same diameter. These four elements are arranged sequentially and are circumscribed by an outer wrapper 150 to form a cylindrical rod. An elongate susceptor 160 is located within the aerosol-forming substrate 110, in contact with the aerosol-forming substrate 110. The susceptor 160 has a length that is approximately the same as the length of the aerosol-forming substrate 110, and is located along a radially central axis of the aerosol-forming substrate 110.

The susceptor 160 comprises at least two different materials. The susceptor 160 is in the form of an elongate strip, preferably having a length of 12 mm and a width of 4 mm. The susceptor 160 comprises at least two layers: a first layer of a first susceptor material disposed in physical contact with a second layer of a second susceptor material. The first susceptor material and the second susceptor material may each have a Curie temperature. In this case, the Curie temperature of the second susceptor material is lower than the Curie temperature of the first susceptor material. The first material may not have a Curie temperature. The first susceptor material may be aluminum, iron or stainless steel. The second susceptor material may be nickel or a nickel alloy. The susceptor 160 may be formed by electroplating at least one patch of the second susceptor material onto a strip of the first susceptor material. The susceptor may be formed by cladding a strip of the second susceptor material to a strip of the first susceptor material. The aerosol-generating article 100 has a proximal or mouth end 170, which a user inserts into his or her mouth during use, and a distal end 180 located at the opposite end of the aerosol-generating article 100 to the mouth end 170. Once assembled, the total length of the aerosol-generating article 100 is preferably about 45 mm and the diameter is about 7.2 mm.

In use, air is drawn through the aerosol-generating article 100 by a user from the distal end 180 to the mouth end 170. The distal end 180 of the aerosol-generating article 100 may also be described as the upstream end of the aerosol-generating article 100 and the mouth end 170 of the aerosol-generating article 100 may also be described as the downstream end of the aerosol-generating article 100. Elements of the aerosol-generating article 100 located between the mouth end 170 and the distal end 180 can be described as being upstream of the mouth end 170 or, alternatively, downstream of the distal end 180. The aerosol-forming substrate 110 is located at the distal or upstream end 180 of the aerosol-generating article 100.

The support element 120 is located immediately downstream of the aerosol-forming substrate 110 and abuts the aerosol-forming substrate 110. The support element 120 may be a hollow cellulose acetate tube. The support element 120 locates the aerosol-forming substrate 110 at the extreme distal end 180 of the aerosol-generating article 100. The support element 120 also acts as a spacer to space the aerosol-cooling element 130 of the aerosol-generating article 100 from the aerosol-forming substrate 110.

The aerosol-cooling element 130 is located immediately downstream of the support element 120 and abuts the support element 120. In use, volatile substances released from the aerosol-forming substrate 110 pass along the aerosol-cooling element 130 towards the mouth end 170 of the aerosol-generating article 100. The volatile substances may cool within the aerosol-cooling element 130 to form an aerosol that is inhaled by the user. The aerosol-cooling element 130 may comprise a crimped and gathered sheet of polylactic acid circumscribed by a wrapper 190. The crimped and gathered sheet of polylactic acid defines a plurality of longitudinal channels that extend along the length of the aerosol-cooling element 130.

The mouthpiece 140 is located immediately downstream of the aerosol-cooling element 130 and abuts the aerosol-cooling element 130. The mouthpiece 140 comprises a conventional cellulose acetate tow filter of low filtration efficiency.

To assemble the aerosol-generating article 100, the four elements 110, 120, 130 and 140 described above are aligned and tightly wrapped within the outer wrapper 150. The outer wrapper may be a conventional cigarette paper. The susceptor 160 may be inserted into the aerosol-forming substrate 110 during the process used to form the aerosol-forming substrate 110, prior to the assembly of the plurality of elements, to form a rod.

The aerosol-generating article 100 illustrated in FIG. 1 is designed to engage with an aerosol-generating device, such as the aerosol-generating device 200 illustrated in FIG. 2A, for producing an aerosol. The aerosol-generating device 200 comprises a housing 210 having a cavity 220 configured to receive the aerosol-generating article 100. The aerosol-generating device 200 further comprises an inductive heating device 230 configured to heat an aerosol-generating article 100 for producing an aerosol. FIG. 2B illustrates the aerosol-generating device 200 when the aerosol-generating article 100 is inserted into the cavity 220.

The inductive heating device 230 is illustrated as a block diagram in FIG. 3. The inductive heating device 230 comprises a DC power source 310 and a heating arrangement 320 (also referred to as power supply electronics). The heating arrangement comprises a controller 330, a DC/AC converter 340, a matching network 350 and an inductor 240.

The DC power source 310 is configured to provide DC power to the heating arrangement 320. Specifically, the DC power source 310 is configured to provide a DC supply voltage (V_{DC}) and a DC current (I_{DC}) to the DC/AC converter 340. Preferably, the power source 310 is a battery, such as a lithium ion battery. As an alternative, the power source 310 may be another form of charge storage device such as a capacitor. The power source 310 may require recharging. For example, the power source 310 may have sufficient capacity to allow for the continuous generation of aerosol for a period of around six minutes or for a period that is a multiple of six minutes. In another example, the power source 310 may have sufficient capacity to allow for a predetermined number of puffs or discrete activations of the heating arrangement.

The DC/AC converter 340 is configured to supply the inductor 240 with a high frequency alternating current. As used herein, the term “high frequency alternating current” means an alternating current having a frequency of between about 500 kilohertz and about 30 megahertz. The high frequency alternating current may have a frequency of between about 1 megahertz and about 30 megahertz, such as between about 1 megahertz and about 10 megahertz, or such as between about 5 megahertz and about 8 megahertz.

FIG. 4 schematically illustrates the electrical components of the inductive heating device 230, in particular the DC/AC converter 340. The DC/AC converter 340 preferably comprises a Class-E power amplifier. The Class-E power amplifier comprises a transistor switch 410 comprising a Field Effect Transistor 420, for example a Metal-Oxide-Semiconductor Field Effect Transistor, a transistor switch supply circuit indicated by the arrow 430 for supplying a switching signal (gate-source voltage) to the Field Effect Transistor 420, and an LC load network 440 comprising a shunt capacitor C1 and a series connection of a capacitor C2 and inductor L2, corresponding to inductor 240. In addition, the DC power source 310, comprising a choke L1, is shown for supplying the DC supply voltage V_{DC}, with a DC current I_{DC} being drawn from the DC power source 310 during operation. The ohmic resistance R representing the total ohmic load 450, which is the sum of the ohmic resistance R_{coil} of the inductor L2 and the ohmic resistance R_{load} of the susceptor 160, is shown in more detail in FIG. 5.

Although the DC/AC converter 340 is illustrated as comprising a Class-E power amplifier, it is to be understood that the DC/AC converter 340 may use any suitable circuitry that converts DC current to AC current. For example, the DC/AC converter 340 may comprise a class-D power amplifier comprising two transistor switches. As another example, the DC/AC converter 340 may comprise a full bridge power inverter with four switching transistors acting in pairs.

Turning back to FIG. 3, the inductor 240 may receive the alternating current from the DC/AC converter 340 via a matching network 350 for optimum adaptation to the load, but the matching network 350 is not essential. The matching network 350 may comprise a small matching transformer. The matching network 350 may improve power transfer efficiency between the DC/AC converter 340 and the inductor 240.

As illustrated in FIG. 2A, the inductor 240 is located adjacent to the distal portion 225 of the cavity 220 of the aerosol-generating device 200. Accordingly, the high frequency alternating current supplied to the inductor 240 during operation of the aerosol-generating device 200 causes the inductor 240 to generate a high frequency alternating magnetic field within the distal portion 225 of the aerosol-generating device 200. The alternating magnetic field preferably has a frequency of between 1 and 30 megahertz, preferably between 2 and 10 megahertz, for example between 5 and 7 megahertz. As can be seen from FIG. 2B, when an aerosol-generating article 100 is inserted into the cavity 200, the aerosol-forming substrate 110 of the aerosol-generating article 100 is located adjacent to the inductor 240 so that the susceptor 160 of the aerosol-generating article 100 is located within this alternating magnetic field. When the alternating magnetic field penetrates the susceptor 160, the alternating magnetic field causes heating of the susceptor 160. For example, eddy currents are generated in the susceptor 160 which is heated as a result. Further heating is provided by magnetic hysteresis losses within the susceptor 160. The heated susceptor 160 heats the aerosol-forming substrate 110 of the aerosol-generating article 100 to a sufficient temperature to form an aerosol. The aerosol is drawn downstream through the aerosol-generating article 100 and inhaled by the user.

The controller 330 may be a microcontroller, preferably a programmable microcontroller. The controller 330 is programmed to regulate the supply of power from the DC power source 310 to the inductive heating arrangement 320 in order to control the temperature of the susceptor 160.

FIG. 6 illustrates the relationship between the DC current I_{DC} drawn from the power source 310 over time as the temperature of the susceptor 160 (indicated by the dashed line) increases. The DC current I_{DC} drawn from the power source 310 is measured at an input side of the DC/AC converter 340. For the purpose of this illustration, it may be assumed that the voltage V D c of the power source 310 remains approximately constant. As the susceptor 160 is inductively heated, the apparent resistance of the susceptor 160 increases. This increase in resistance is observed as a decrease in the DC current I_{DC} drawn from the power source 310, which at constant voltage decreases as the temperature of the susceptor 160 increases. The high frequency alternating magnetic field provided by the inductor 240 induces eddy currents in close proximity to the susceptor surface, an effect that is known as the skin effect. The resistance in the susceptor 160 depends in part on the electrical resistivity of the first susceptor material, the resistivity of the second susceptor material and in part on the depth of the skin layer in each material available for induced eddy currents, and the resistivity is in turn temperature dependent. As the second susceptor material reaches its Curie temperature, it loses its magnetic properties. This causes an increase in the skin layer available for eddy currents in the second susceptor material, which causes a decrease in the apparent resistance of the susceptor 160. The result is a temporary increase in the detected DC current I_{DC} when the skin depth of the second susceptor material begins to increase, the resistance begins to fall. This is seen as the valley (the local minimum) in FIG. 6. The current continues to increase until the maximum skin depth is reached, which coincides with the point where the second susceptor material has lost its spontaneous magnetic properties. This point is called the Curie temperature and is seen as the hill (the local maximum) in FIG. 6. At this point the second susceptor material has undergone a phase change from a ferro-magnetic or ferri-magnetic state to a paramagnetic state. At this point, the susceptor 160 is at a known temperature (the Curie temperature, which is an intrinsic material-specific temperature). If the inductor 240 continues to generate an alternating magnetic field (i.e. power to the DC/AC converter 340 is not interrupted) after the Curie temperature has been reached, the eddy currents generated in the susceptor 160 will run against the resistance of the susceptor 160, whereby Joule heating in the susceptor 160 will continue, and thereby the resistance will increase again (the resistance will have a polynomial dependence of the temperature, which for most metallic susceptor materials can be approximated to a third degree polynomial dependence for our purposes) and current will start falling again as long as the inductor 240 continues to provide power to the susceptor 160.

Therefore, as can be seen from FIG. 6, the apparent resistance of the susceptor 160 (and correspondingly the current I_{DC} drawn from the power source 310) may vary with the temperature of the susceptor 160 in a strictly monotonic relationship over certain ranges of temperature of the susceptor 160. The strictly monotonic relationship allows for an unambiguous determination of the temperature of the susceptor 160 from a determination of the apparent resistance or apparent conductance (1/R). This is because each determined value of the apparent resistance is representative of only one single value of the temperature, so that there is no ambiguity in the relationship. The monotonic relationship of the temperature of the susceptor 160 and the apparent resistance allows for the determination and control of the temperature of the susceptor 160 and thus for the determination and control of the temperature of the aerosol-forming substrate 110. The apparent resistance of the susceptor 160 can be remotely detected by monitoring at least the DC current I_{DC} drawn from the DC power source 310.

At least the DC current I_{DC} drawn from the power source 310 is monitored by the controller 330. Preferably, both the DC current I_{DC} drawn from the power source 310 and the DC supply voltage V D c are monitored. The controller 330 regulates the supply of power provided to the heating arrangement 320 based on a conductance value or a resistance value, where conductance is defined as the ratio of the DC current I_{DC} to the DC supply voltage V_{DC} and resistance is defined as the ratio of the DC supply voltage V_{DC} to the DC current I_{DC}. The heating arrangement 320 may comprise a current sensor (not shown) to measure the DC current I_{DC}. The heating arrangement may optionally comprise a voltage sensor (not shown) to measure the DC supply voltage V_{DC}. The current sensor and the voltage sensor are located at an input side of the DC/AC converter 340. The DC current I_{DC} and optionally the DC supply voltage V_{DC} are provided by feedback channels to the controller 330 to control the further supply of AC power PAC to the inductor 240.

The controller 330 may control the temperature of the susceptor 160 by maintaining the measured conductance value or the measured resistance value at a target value corresponding to a target operating temperature of the susceptor 160. The controller 330 may use any suitable control loop to maintain the measured conductance value or the measured resistance value at the target value, for example by using a proportional-integral-derivative control loop.

In order to take advantage of the strictly monotonic relationship between the apparent resistance (or apparent conductance) of the susceptor 160 and the temperature of the susceptor 160, during user operation for producing an aerosol, the conductance value or the resistance value associated with the susceptor and measured at the input side of the DC/AC converter 340 is maintained between a first calibration value corresponding to a first calibration temperature and a second calibration value corresponding to a second calibration temperature. The second calibration temperature is the Curie temperature of the second susceptor material (the hill in the current plot in FIG. 6). The first calibration temperature is a temperature greater than or equal to the temperature of the susceptor at which the skin depth of the second susceptor material begins to increase (leading to a temporary lowering of the resistance). Thus, the first calibration temperature is a temperature greater than or equal to the temperature at maximum permeability of the second susceptor material. The first calibration temperature is at least 50 degrees Celsius lower than the second calibration temperature. At least the second calibration value may be determined by calibration of the susceptor 160, as will be described in more detail below. The first calibration value and the second calibration value may be stored as calibration values in a memory of the controller 330.

Since the conductance (resistance) will have a polynomial dependence on the temperature, the conductance (resistance) will behave in a nonlinear manner as a function of temperature. However, the first and the second calibration values are chosen so that this dependence may be approximated as being linear between the first calibration value and the second calibration value because the difference between the first and the second calibration values is small, and the first and the second calibration values are in the upper part of the operational temperature range. Therefore, to adjust the temperature to a target operating temperature, the conductance is regulated according to the first calibration value and the second calibration value, through linear equations. For example, if the first and the second calibration values are conductance values, the target conductance value corresponding to the target operating temperature may be given by:

G_{Target}=G_{Lower}+(x×ΔG)

where ΔG is the difference between the first conductance value and the second conductance value and x is a percentage of ΔG.

The controller 330 may control the provision of power to the heating arrangement 320 by adjusting the duty cycle of the switching transistor 410 of the DC/AC converter 340. For example, during heating, the DC/AC converter 340 continuously generates alternating current that heats the susceptor 160, and simultaneously the DC supply voltage V_{DC} and the DC current I_{DC} may be measured, preferably every millisecond for a period of 100 milliseconds. If the conductance is monitored by the controller 330, when the conductance reaches or exceeds a value corresponding to the target operating temperature, the duty cycle of the switching transistor 410 is reduced. If the resistance is monitored by the controller 330, when the resistance reaches or goes below a value corresponding to the target operating temperature, the duty cycle of the switching transistor 410 is reduced. For example, the duty cycle of the switching transistor 410 may be reduced to about 9%. In other words, the switching transistor 410 may be switched to a mode in which it generates pulses only every 10 milliseconds fora duration of 1 millisecond. During this 1 millisecond on-state (conductive state) of the switching transistor 410, the values of the DC supply voltage V_{DC} and of the DC current I_{DC} are measured and the conductance is determined. As the conductance decreases (or the resistance increases) to indicate that the temperature of the susceptor 160 is below the target operating temperature, the gate of the transistor 410 is again supplied with the train of pulses at the chosen drive frequency for the system.

The power may be supplied by the controller 330 to the inductor 240 in the form of a series of successive pulses of electrical current. In particular, power may be supplied to the inductor 240 in a series of pulses, each separated by a time interval. The series of successive pulses may comprise two or more heating pulses and one or more probing pulses between successive heating pulses. The heating pulses have an intensity such as to heat the susceptor 160. The probing pulses are isolated power pulses having an intensity such not to heat the susceptor 160 but rather to obtain a feedback on the conductance value or resistance value and then on the evolution (decreasing) of the susceptor temperature. The controller 330 may control the power by controlling the duration of the time interval between successive heating pulses of power supplied by the DC power supply to the inductor 240. Additionally or alternatively, the controller 330 may control the power by controlling the length (in other words, the duration) of each of the successive heating pulses of power supplied by the DC power supply to the inductor 240.

The controller 330 is programmed to perform a calibration process in order to obtain the calibration values at which the conductance is measured at known temperatures of the susceptor 160. The known temperatures of the susceptor may be the first calibration temperature corresponding to the first calibration value and the second calibration temperature corresponding to the second calibration value. Preferably, the calibration process is performed each time the user operates the aerosol-generating device 200, for example each time the user inserts an aerosol-generating article 100 into an aerosol-generating device 200.

During the calibration process, the controller 330 controls the DC/AC converter 340 to continuously or continually supply power to the inductor 240 in order to heat the susceptor 160. The controller 330 monitors the conductance or resistance associated with the susceptor 160 by measuring the current I_{DC} drawn by the power supply and, optionally the power supply voltage V_{DC}. As discussed above in relation to FIG. 6, as the susceptor 160 is heated, the measured current decreases until a first turning point is reached and the current begins to increase. This first turning point corresponds to a local minimum conductance value (a local maximum resistance value). The controller 330 may record the local minimum value of conductance (or local maximum of resistance) as the first calibration value. The controller may record the value of conductance or resistance at a predetermined time after the minimum current has been reached as the first calibration value. The conductance or resistance may be determined based on the measured current I_{DC} and the measured voltage V_{DC}. Alternatively, it may be assumed that the power supply voltage V_{DC}, which is a known property of the power source 310, is approximately constant. The temperature of the susceptor 160 at the first calibration value is referred to as the first calibration temperature. Preferably, the first calibration temperature is between 150 degrees Celsius and 350 degrees Celsius. More preferably, when the aerosol-forming substrate 110 comprises tobacco, the first calibration temperature is 320 degrees Celsius. The first calibration temperature is at least 50 degrees Celsius lower than the second calibration temperature.

As the controller 330 continues to control the power provided by the DC/AC converter 340 to the inductor 240, the measured current increases until a second turning point is reached and a maximum current is observed (corresponding to the Curie temperature of the second susceptor material) before the measured current begins to decrease. This turning point corresponds to a local maximum conductance value (a local minimum resistance value). The controller 330 records the local maximum value of the conductance (or local minimum of resistance) as the second calibration value. The temperature of the susceptor 160 at the second calibration value is referred to as the second calibration temperature. Preferably, the second calibration temperature is between 200 degrees Celsius and 400 degrees Celsius. When the maximum is detected, the controller 330 controls the DC/AC converter 340 to interrupt provision of power to the inductor 240, resulting in a decrease in susceptor 160 temperature and a corresponding decrease in conductance.

Due to the shape of the graph, this process of continuously heating the susceptor 160 to obtain the first calibration value and the second calibration value may be repeated at least once. After interrupting provision of power to the inductor 240, the controller 330 continues to monitor the conductance (or resistance) until a third turning point corresponding to a second minimum conductance value (a second maximum resistance value) is observed. When the third turning point is detected, the controller 330 controls the DC/AC converter 340 to continuously provide power to the inductor 240 until a fourth turning point corresponding to a second maximum conductance value (second minimum resistance value) is detected. The controller 330 stores the conductance value or the resistance value at or just after the third turning point as the first calibration value and the conductance value or the resistance value at the fourth turning point current as the second calibration value. The repetition of the measurement of the turning points corresponding to minimum and maximum measured current significantly improves the subsequent temperature regulation during user operation of the device for producing an aerosol. Preferably, controller 330 regulates the power based on the conductance or resistance values obtained from the second maximum and the second minimum, this being more reliable because the heat will have had more time to distribute within the aerosol-forming substrate 110 and the susceptor 160.

In order to further improve the reliability of the calibration process, the controller 310 may be optionally programmed to perform a pre-heating process before the calibration process. For example, if the aerosol-forming substrate 110 is particularly dry or in similar conditions, the calibration may be performed before heat has spread within the aerosol-forming substrate 110, reducing the reliability of the calibration values. If the aerosol-forming substrate 110 were humid, the susceptor 160 takes more time to reach the valley temperature (due to water content in the substrate 110).

To perform the pre-heating process, the controller 330 is configured to continuously provide power to the inductor 240. As described above, the current starts decreasing with increasing susceptor 160 temperature until the minimum is reached. At this stage, the controller 330 is configured to wait for a predetermined period of time to allow the susceptor 160 to cool before continuing heating. The controller 330 therefore controls the DC/AC converter 340 to interrupt provision of power to the inductor 240. After the predetermined period of time, the controller 330 controls the DC/AC converter 340 to provide power until the minimum is reached. At this point, the controller controls the DC/AC converter 340 to interrupt provision of power to the inductor 240 again. The controller 330 again waits for the same predetermined period of time to allow the susceptor 160 to cool before continuing heating. This heating and cooling of the susceptor 160 is repeated for the predetermined duration of time of the pre-heating process. The predetermined duration of the pre-heating process is preferably 11 seconds. The predetermined combined durations of the pre-heating process followed by the calibration process is preferably 20 seconds.

If the aerosol-forming substrate 110 is dry, the first minimum of the pre-heating process is reached within the pre-determined period of time and the interruption of power will be repeated until the end of the predetermined time period. If the aerosol-forming substrate 110 is humid, the first minimum of the pre-heating process will be reached towards the end of the pre-determined time period. Therefore, performing the pre-heating process for a predetermined duration ensures that, whatever the physical condition of the substrate 110, the time is sufficient for the substrate 110 to reach the minimum temperature, in order to be ready to feed continuous power and reach the first maximum. This allows a calibration as early as possible, but still without risking that the substrate 110 would not have reached the valley beforehand.

Further, the aerosol-generating article 100 may be configured such that the minimum is always reached within the predetermined duration of the pre-heating process. If the minimum is not reached within the pre-determined duration of the pre-heating process, this may indicate that the aerosol-generating article 100 comprising the aerosol-forming substrate 110 is not suitable for use with the aerosol-generating device 200. For example, the aerosol-generating article 100 may comprise a different or lower-quality aerosol-forming substrate 110 than the aerosol-forming substrate 100 intended for use with the aerosol-generating device 200. As another example, the aerosol-generating article 100 may not be configured for use with the heating arrangement 320, for example if the aerosol-generating article 100 and the aerosol-generating device 200 are manufactured by different manufacturers. Thus, the controller 330 may be configured to generate a control signal to cease operation of the aerosol-generating device 200.

The pre-heating process may be performed in response to receiving a user input, for example user activation of the aerosol-generating device 200. Additionally or alternatively, the controller 330 may be configured to detect the presence of an aerosol-generating article 100 in the aerosol-generating device 200 and the pre-heating process may be performed in response to detecting the presence of the aerosol-generating article 100 within the cavity 220 of the aerosol-generating device 200.

FIG. 7 is a graph of conductance against time showing a heating profile of the susceptor 160. The graph illustrates two consecutive phases of heating: a first heating phase 710 comprising the pre-heating process 710A and the calibration process 710B described above, and a second heating phase 720 corresponding to user operation of the aerosol-generating device 200 to produce an aerosol. Although FIG. 7 is illustrated as a graph of conductance against time, it is to be understood that the controller 330 may be configured to control the heating of the susceptor during the first heating phase 710 and the second heating phase 720 based on measured resistance or current as described above.

Further, although the techniques to control of the heating of the susceptor during the first heating phase 710 and the second heating phase 720 have been described above based on a determined conductance value or a determined resistance value associated with the susceptor, it is to be understood that the techniques described above could be performed based on a value of current measured at the input of the DC/AC converter 340.

As can be seen from FIG. 7, the second heating phase 720 comprises a plurality of conductance steps, corresponding to a plurality of temperature steps from a first operating temperature of the susceptor 160 to a second operating temperature of the susceptor 160. The first operating temperature of the susceptor is a minimum temperature at which the aerosol-forming substrate will form an aerosol in a sufficient volume and quantity for a satisfactory experience when inhaled a user. The second operating temperature of the susceptor is the temperature at maximum temperature at which it is desirable for the aerosol-forming substrate to be heated for the user to inhale the aerosol. The first operating temperature of the susceptor 160 is greater than or equal to the first calibration temperature of the susceptor 160 at the valley of the current plot shown in FIG. 6. The first operating temperature may be between 150 degrees Celsius and 330 degrees Celsius. The second operating temperature of the susceptor is less than or equal to the second calibration temperature of the susceptor 160 at the Curie temperature of the second susceptor material. The second operating temperature may be between 200 degrees Celsius and 400 degrees Celsius. The difference between the first operating temperature and the second operating temperature is at least 50 degree Celsius. The first operating temperature of the susceptor is a temperature at which the aerosol-forming substrate 110 forms an aerosol so that an aerosol is formed during each temperature step.

It is to be understood that the number of temperature steps illustrated in FIG. 7 is exemplary and that second heating phase 720 comprises at least three consecutive temperature steps, preferably between two and fourteen temperature steps, most preferably between three and eight temperature steps. Each temperature step may have a predetermined duration. Preferably the duration of the first temperature step is longer than the duration of subsequent temperature steps. The duration of each temperature step is preferably longer than 10 seconds, preferably between 30 seconds and 200 seconds, more preferably between 40 seconds and 160 seconds. The duration of each temperature step may correspond to a predetermined number of user puffs. Preferably, the first temperature step corresponds to four user puffs and each subsequent temperature step corresponds to one user puff.

For the duration of each temperature step, the temperature of the susceptor 160 is maintained at a target operating temperature corresponding to the respective temperature step. Thus, for the duration of each temperature step, the controller 330 controls the provision of power to the heating arrangement 320 such that the conductance is maintained at a value corresponding to the target operating temperature of the respective temperature step as described above. Target conductance values for each temperature step may be stored in the memory of the controller 330.

As an example, the second heating phase 720 may comprise five temperature steps: a first temperature step having a duration of 160 seconds and a target conductance value of G_{Target} G_{Lower}+(0.09×ΔG), a second temperature step having a duration of 40 seconds and a target conductance value of G_{Target}=G_{Lower}+(0.25×ΔG), a third temperature step having a duration of 40 seconds and a target conductance value of G_{Target}=G_{Lower} (0.4×ΔG), a fourth temperature step having a duration of 40 seconds and a target conductance value of G_{Target} G_{Lower}+(0.56×ΔG) and a fifth temperature step having a duration of 85 seconds and a target conductance value of G_{Target}=G_{Lower}+(0.75×ΔG). These temperature steps may correspond to temperatures of 330 degrees Celsius, 340 degrees Celsius, 345 degrees Celsius, 355 degrees Celsius and 380 degrees Celsius. FIG. 8 is a flow diagram of a method 800 for controlling aerosol-production in an aerosol-generating device 200. As described above, the controller 330 may be programmed to perform the method 800.

The method begins at step 810, where the controller 330 detects user operation of the aerosol-generating device 200 for producing an aerosol. Detecting user operation of the aerosol-generating device 200 may comprise detecting a user input, for example user activation of the aerosol-generating device 200. Additionally or alternatively, detecting user operation of the aerosol-generating device 200 may comprise detecting that an aerosol-generating article 100 has been inserted into the aerosol-generating device 200.

In response to detecting the user operation at step 810, the controller 330 may be configured to perform the optional pre-heating process described above. At the end of the predetermined duration of the pre-heating process, the controller 330 performs the calibration process (step 820) as described above. Alternatively, the controller 330 may be configured to proceed to step 820 in response to detecting the user operation at step 810. Following completion of the calibration process, the controller 330 performs the second heating phase in which the aerosol is produced at step 840.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-113. (canceled)

114. A method for controlling aerosol production in an aerosol-generating device, the aerosol-generating device comprising an inductive heating arrangement and a power source configured to provide power to the inductive heating arrangement, and the method comprising:
performing, during a first heating phase during user operation of the aerosol-generating device for producing an aerosol, a calibration process comprising measuring one or more calibration values associated with a susceptor inductively coupled to the inductive heating arrangement, wherein the susceptor is configured to heat an aerosol-forming substrate; and
during a second heating phase during the user operation of the aerosol-generating device for producing the aerosol, controlling power provided to the inductive heating arrangement such that a temperature of the susceptor is adjusted based on the one or more calibration values.

115. The method according to claim 114, wherein the performing the calibration process further comprises the steps of:
(i) controlling the power provided to the inductive heating arrangement to cause an increase of the temperature of the susceptor,
(ii) monitoring a at least a current value associated with the susceptor,
(iii) interrupting provision of power to the inductive heating arrangement when the current value reaches a maximum, wherein the current value at the maximum corresponds to a second calibration temperature of the susceptor, and
(iv) monitoring the current value associated with the susceptor until the current value reaches a minimum, wherein the current value at the minimum corresponds to a first calibration temperature of the susceptor.

116. The method according to claim 115, wherein the performing the calibration process further comprises:
repeating steps i) to iv) when the current value associated with the susceptor reaches the minimum, and
during the repeating of steps i) to iv), storing the current value at the maximum as a calibration value of the one or more calibration values and storing the current value at the minimum as a calibration value of the one or more calibration values.

117. The method according to claim 115, wherein the controlling the power provided to the inductive heating arrangement comprises maintaining a current value associated with the susceptor between a first current value corresponding to the first calibration temperature and a second current value corresponding to the second calibration temperature.

118. The method according to claim 115,
wherein the second calibration temperature of the susceptor corresponds to a Curie temperature of a material of the susceptor, and
wherein the first calibration temperature of the susceptor corresponds to a temperature at maximum permeability of the material of the susceptor.

119. The method according to claim 114,
further comprising, during the first heating phase, performing a pre-heating process,
wherein the pre-heating process is performed before the calibration process, and
wherein the pre-heating process has a predetermined duration.

120. The method according to claim 119, wherein the pre-heating process comprises the steps of:
i) controlling the power provided to the inductive heating arrangement to cause an increase of the temperature of the susceptor,
ii) monitoring at least a current value associated with the susceptor, and
iii) interrupting provision of power to the inductive heating arrangement when the current value reaches a minimum.

121. The method according to claim 120, further comprising, if the current value reaches a minimum before an end of the predetermined duration of the pre-heating process, repeating steps i) to iii) of the pre-heating process until the end of the predetermined duration of the pre-heating process.

122. The method according to claim 121, further comprising, if the current value associated with the susceptor does not reach a minimum during the predetermined duration of pre-heating process, ceasing operation of the aerosol-generating device.

123. The method according to claim 117,
wherein the aerosol-generating device is configured to receive the aerosol-generating article,
wherein the aerosol-generating article comprises the susceptor and the aerosol-forming substrate, and
wherein the pre-heating process is performed in response to detecting a presence of the aerosol-generating article.

124. The method according to claim 114, wherein the controlling the power provided to the inductive heating arrangement during the second heating phase comprises controlling the power to the inductive heating arrangement to cause a step-wise increase of a temperature of the susceptor from a first operating temperature to a second operating temperature.

125. An aerosol-generating device, comprising:
a power source configured to provide a DC supply voltage and a DC current;
power supply electronics connected to the power source, the power supply electronics comprising a DC/AC converter and an inductor connected to the DC/AC converter and being configured to generate an alternating magnetic field when energized by an alternating current from the DC/AC converter, the inductor being couplable to a susceptor, wherein the susceptor is configured to heat an aerosol-forming substrate; and
a controller configured to:
perform, during a first heating phase during user operation of the aerosol-generating device for producing an aerosol, a calibration process comprising measuring one or more calibration values associated with the susceptor, and
during a second heating phase during the user operation of the aerosol-generating device for producing the aerosol, control power provided to the power supply electronics such that a temperature of the susceptor is adjusted based on the one or more calibration values.

126. The aerosol-generating device according to claim 125, wherein performing the calibration process comprises the steps of:
(i) controlling the power provided to the power supply electronics to cause an increase of the temperature of the susceptor,
(ii) monitoring a current value associated with the susceptor,
(iii) interrupting provision of power to the power supply electronics when the current value reaches a maximum, wherein the current value at the maximum corresponds to a second calibration temperature of the susceptor, and
(iv) monitoring the current value associated with the susceptor until the current value reaches a minimum, wherein the current value at the minimum corresponds to a first calibration temperature of the susceptor.

127. The aerosol-generating device according to claim 126, wherein performing the calibration process further comprises repeating steps i) to iv) when the current value associated with the susceptor reaches the minimum.

128. The aerosol-generating device according to claim 127, wherein performing the calibration process further comprises, during the repeating of steps i) to iv), storing the current value at the maximum as a calibration value of the one or more calibration values and storing the current value at the minimum as a calibration value of the one or more calibration values.

129. The aerosol-generating device according to claim 126, wherein controlling the power provided to the inductive heating arrangement comprises maintaining a current value associated with the susceptor between a first current value corresponding to the first calibration temperature and a second current value corresponding to the second calibration temperature.

130. The aerosol-generating device according to claim 125,
wherein the controller is further configured to, during the first heating phase, perform a pre-heating process,
wherein the pre-heating process is performed before the calibration process, and
wherein the pre-heating process has a predetermined duration.

131. The aerosol-generating device according to claim 130, wherein the controller is configured to perform the pre-heating process in response to detecting a presence of an aerosol-generating article.

132. The aerosol-generating device according to claim 125, wherein controlling the power provided to the power supply electronics during the second heating phase comprises controlling the power to the power supply electronics to cause a step-wise increase of a temperature of the susceptor from a first operating temperature to a second operating temperature.

133. An aerosol-generating system, comprising:
the aerosol-generating device according to claim 125; and
an aerosol-generating article comprising the aerosol-forming substrate and the susceptor.
